(19) United States
(12) Patent Application Publication
(10) Pub. No.: US 2004/0127382 A1
(43) Pub. Date: Jul. 1, 2004

(54) Use of transition metal complexes with nitrogen-containing polydentate ligands as a bleaching catalyst and bleaching agent composition

(76) Inventors: Ulrike Kunz, Gelnhausen (DE); Harald Jakob, Hasselroth (DE); Michael del Grosso, (US); Astrid Dorfer, Grundau (DE)

Correspondence Address: FITCH, EVEN, TABIN & FLANNERY, SUITE 401L, 1801 K STREET, NW, WASHINGTON, DC, 20006-1201, US

(21) Appl. No.: 10/459,719

(22) Filed: Jun. 12, 2003

(30) Foreign Application Priority Data
Jun. 14, 2002 (DE) 102 26 522.4

(51) Int. Cl. C11D 3/00

(52) U.S. Cl. 510/376

(57) ABSTRACT

The present invention is directed to transition metal complexes that are used as bleaching catalysts for peroxy compounds. The transition metal complexes contain a pentadentate ligand of the general formula

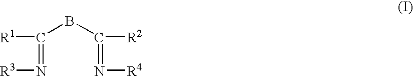

wherein B preferably denotes a heterocyclic or heteroaromatic member of the formula

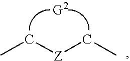

in particular pyridine-2,6-diyl, R¹—C═N—R⁴ and

R²—C═N—R⁴ represent a heterocyclic or heteroaromatic ring or R³ and/or R⁴ represent a heteroaryl, aryl or heteroarylmethyl radical.

### CROSS REFERENCE TO RELATED APPLICATIONS

This application claims priority to German Application No. 102 26 522.4, filed Jun. 14, 2002, which is incorporated in its entirety herein by reference.

### FIELD OF THE INVENTION

The present invention relates to the use of transition metal complexes with nitrogen-containing polydentate ligands as bleaching catalysts and to bleaching agent compositions comprising such catalysts. The activity of peroxy compounds in washing, bleaching and cleaning processes at low temperature is increased by the transition metal complexes.

### BACKGROUND OF THE INVENTION

Inorganic peroxy compounds (particularly hydrogen peroxide and compounds which liberate hydrogen peroxide, such as sodium perborate monohydrate, sodium perborate tetrahydrate and sodium percarbonate) have been employed for a long time as oxidizing agents in bleaching, washing and cleaning processes. Typically, sufficiently rapid bleaching of soiled textiles requires a temperature of at least 80° C. However, the oxidizing action of inorganic peroxygen compounds at reduced temperature can be improved using bleaching activators. These activators are, in particular, N- and O-acyl compounds, for example polyacylated alkylenediamines (such as tetraacetylethylenediamine (TAED)), acetylated glycolurils, N-acetylated hydantoins, diketopiperazines, carboxylic acid anhydrides, carboxylic acid esters (such as, in particular, sodium nonanoyloxy-benzenesulfonate (NOBS)), and acylated sugar derivatives.

Using a combination of a peroxy compound and an activator, bleaching can be carried out at about 60° C. instead of above 80° C. without a loss in activity. In efforts to carry out washing and bleaching below 60° C., the use of transition metal complexes (in particular complexes of manganese, iron, cobalt and copper), with at least one polydentate organic ligand (in particular nitrogen-containing ligands), has been described in many documents. Reference is made by way of example to the complexes described in: EP 0 544 490, WO 98/54282, WO 00/12808, WO 00/60043, WO 00/52124, EP 0 392 592, WO 99/64156 and WO 00/12667.

Unfortunately, attempts to use transition metal complexes below 60° C. have been only partially successful. If reactivity is too high, there is the risk of a change in the colour of dyed textiles and, in the extreme, of oxidative damage to the fibres. Furthermore, some complexes decompose the peroxygen compound without a bleaching action, are insufficiently stable to hydrolysis, or are susceptible to oxidation.

EP Patent Application no. 0392592 teaches that the bleaching action of peroxy compounds can be activated in the presence of a catalytic amount of a complex of a transition metal from the series consisting of manganese, cobalt, iron and copper with a non-macrocyclic ligand of the general formula (I)

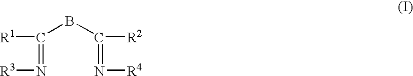

The bridge member B is O, S, CR⁵R⁶, NR⁷ or C═O. The groupings R¹—C═N—R³ and R²—C═N—R⁴ can form a five- or six-membered, optionally substituted, heterocyclic ring. As the examples in the application show, 2,2′-dipyridylamine is always to be used as the ligand L. However, with this bleaching catalyst, there is the risk of a change in the colour of dyed textiles and, in some cases, oxidative damage.

Bleaching catalysts having an organic nitrogen-containing ligand are also described in WO 00/32731. In this case, the ligand di(2-pyridyl)methylamine (which can also be N-substituted) is used to increase the oxidizing and bleaching action of hydrogen peroxide. A further increase can be achieved by combining a bleaching catalyst with an activator capable of forming a peroxycarboxylic acid in the presence of a source of hydrogen peroxide. As has been shown in practice, different property profiles of bleaching catalysts are required in washing, bleaching and cleaning compositions and the products that are presently available do not fully meet the diverse needs of the trade.

### DESCRIPTION OF THE INVENTION

The present invention is based upon the discovery that transition metal complexes having a transition metal from the series consisting of manganese, iron, cobalt or copper are very active and gentle bleaching catalysts if the complexes also have at least one nitrogen-containing polydentate ligand of the general formula (I) shown below. The bridge member B and the radicals R¹ to R⁴ as defined herein result in a structure that differs from that of previously described ligands.

The invention thus provides transition metal complexes with at least one nitrogen-containing polydentate ligand as a bleaching catalyst for activation of a peroxy compound or of oxygen. The complexes may be mono- or polynuclear, the transition metal (M) may be manganese, iron, cobalt or copper, and the nitrogen-containing ligand (L), at least one of which is present, has the general formula (I):

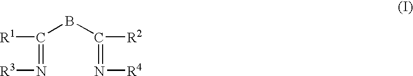

wherein B represents a bridge member from the series consisting of —O—, —S—

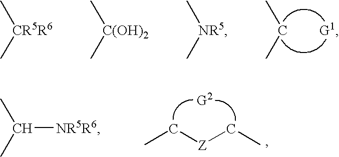

R¹ and R² independently of one another represent a radical from the series consisting of H, linear, cyclic or branched alkyl, heteroalkyl, aryl, heteroaryl, arylalkyl and heteroarylalkyl,

R³ and R⁴ independently of one another represent a radical from the series consisting of aryl, heteroaryl, alkoxy, arylalkoxy, heteroarylalkyl and arylalkyl, wherein the organic radicals of R¹ to R⁴ can be substituted,

the group R¹—C═N—R³ and/or R²—C═N—R⁴ independently of one another represent a five- to seven-membered N-heterocyclic or N-heteroaromatic ring, which additionally can contain one or two further heteroatoms from the series consisting of O, N and S and can be substituted,

the bridge member

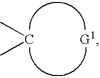

represents a five- or six-membered optionally substituted cycloalkyl or heterocycloalkyl group with 1 to 3 heteroatoms from the series consisting of N, O and S and

the bridge member

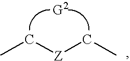

represents a five- to seven-membered optionally substituted cycloaliphatic, aromatic, heterocyclic or heteroaromatic radical, wherein Z is chosen from the series consisting of O, —N(R⁶)—, —N═ or —C(OH)₂— and the group G² can contain one or two heteroatoms from the series consisting of O, N and S and/or substituents,

R⁵ and R⁶ are independent of one another and are defined according to the definition for R¹;

substituents in R¹ to R⁶ and G¹ and G² are chosen from the series consisting of functional and non-functional substituents, such as, in particular, OH, COOH, SO₃H, NH₂, N⁺(alkyl)₄, SO₃⁻, CO₃⁻, Cl, F, (C₁-C₄)-alkoxy, (C₁-C₄)alkyl, phenyl, benzyl, pyridyl and 2-pyridylmethyl;

and with the proviso that ligands in which the bridge member B represents

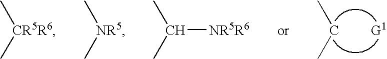

are excluded in cases where the ring system formed from R¹—C═N—R³ and/or R²—C═N—R⁴ denotes something other than an optionally substituted 1,3-oxazolin-2-yl ring and in cases where R³ and R⁴ are something other than heteroaryl, heteroarylmethyl, alkoxy or aryloxy.

The present invention is also directed to bleaching agent compositions which comprise a peroxy compound, in particular a source of hydrogen peroxide, and a transition metal complex in an amount effective for activation of the peroxy compound. The transition metal complex can be mono- or polynuclear and contains as the transition metal one from the series consisting of manganese in the valency level II to IV, iron in the valency level II or III, cobalt in the valency level II or III and copper in the valency level I or II. Depending on the number of heteroatoms capable of ligand formation and their steric alignment in the ligand (L), the complex can contain one or more transition metal atoms, preferably one or two metal atoms of the same type. The complex has the general formula:

[LₘMₙXₒ]Yₚ.

In this formula, L denotes a ligand as described above, M denotes a transition metal atom from the above-mentioned series, X denotes a coordinating neutral, mono- or polyvalent ligand for saturation of the ligand sphere and Y denotes a non-coordinating counter-ion, which can be anionic or, if the sum of anionic ligands X and ionic substituents in the ligand L exceeds the sum of the valency of the metal atoms M, can also be cationic. The index m represents an integer in the range from 1 to 4, in particular 1 or 2, the index n represents an integer, preferably 1 or 2, the index o represents zero or an integer in the range from 1 to 8 and the index p represents zero or an integer in order to achieve a complete charge compensation. Y can also be a substituent, such as carboxylate or sulfonate, in the ligand.

The polydentate ligand L to be used according to the invention has the structure according to the general formula (I) already shown. According to a preferred embodiment, the two radicals bonded to the bridge member B are identical, so that in these cases also R¹=R² and R³=R⁴. According to a preferred embodiment, the bridge member B corresponds to a five- to seven-membered, in particular five- or six-membered ring system according to the general formula:

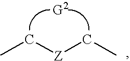

The ring system can be a cycloalkyl group in which Z represents the ketone hydrate structural element —C(OH)₂—. In preferred ligands, however, B represents a heterocyclic radical where Z=—N(R⁶)— or a heteroaromatic radical wherein Z can represent —N(R⁶), —O— or —N═. Examples of heterocyclic and heteroaromatic bridge members are: pyridine-2,6-diyl, pyrrole-2,5-diyl, imidazole-2,5-diyl, piperidine-2,6-diyl, morpholino-3,5-diyl, pyrrolidine-2,5-diyl, 1,3,5-triazine-2,6-diyl.

The cyclic bridge members B can also have functional or non-functional substituents, for example OH, NH₂, COOH, SO₃H, COOMe, SO₃Me, wherein Me represents an alkali metal, N⁺(C₁-C₄-alkyl)₄, F, Cl, alkoxy, in particular (C₁-C₄)alkoxy, alkyl, in particular (C₁-C₄)alkyl, phenyl, benzyl, pyridyl, 2-pyridylmethyl.

The radicals R¹ and R² in the ligand L can be identical or different and represent H, linear, cyclic or branched alkyl or heteroalkyl, aryl, heteroaryl, arylalkyl and

The cyclic bridge members B can also have functional or non-functional substituents, for example OH, NH₂, COOH, SO₃H, COOMe, SO₃Me, wherein Me represents an alkali metal, N⁺(C₁-C₄-alkyl)₄, F, Cl, alkoxy, in particular (C₁-C₄)alkoxy, alkyl, in particular (C₁-C₄)alkyl, phenyl, benzyl, pyridyl, 2-pyridylmethyl.

The radicals R¹ and R² in the ligand L can be identical or different and represent H, linear, cyclic or branched alkyl or heteroalkyl, aryl, heteroaryl, arylalkyl and heteroarylalkyl. Examples are methyl, ethyl, i-propyl, tert-butyl, benzyl, phenyl, pyridyl, in particular 2-pyridyl, 1,3-oxazolin-2-yl, 1,3-oxazolin-2-methyl and 2-pyridylmethyl.

The radicals R³ and R⁴ in the ligand L can be, independently of one another, aryl, heteroaryl, alkoxy, aryloxy, heteroaryl, alkyl and arylalkyl. The examples mentioned above for R¹ and R² also apply here. If R³ and/or R⁴ represents alkoxy or aryloxy, they are preferably methoxy, ethoxy, 2-hydroxyethoxy, 2-aminoethoxy, 2-N,N-di(C₁-C₄)alkylaminoethoxy and phenoxy.

According to a preferred embodiment, the groupings R¹—C═N—R³ and/or R²—C═N—R⁴ form a five- or six-membered N-heterocyclic or N-heteroaromatic ring, which additionally can contain one or two heteroatoms, in particular oxygen or nitrogen, and can also be substituted.

Both the radicals R¹ to R⁴ and the above-mentioned cyclic groupings which are bonded to the bridge member B can have one or more functional or non-functional substituents. These are the same substituents as have already been disclosed in connection with the description of the bridge member B. According to particularly preferred embodiments, the heterocyclic or heteroaromatic ring systems bonded to the bridge member B contain one or more linear or branched (C₁- to C₄)alkyl groups, in particular methyl, isopropyl and tert-butyl, and furthermore phenyl, benzyl, 2-pyridylmethyl or -ethyl or 4-imidazolylmethyl or -ethyl.

According to a further preferred embodiment, the radicals R¹ to R⁴ or the nitrogen-containing ring systems formed therefrom contain hydrophilic substituents in order to increase the solubility of the complex. Examples of these are salt-forming functional substituents and hydroxyalkoxy groupings, which can also contain one or more ether bridges.

According to a particularly preferred embodiment, 1,3-oxazolin-2-yl radicals are bonded to the bridge member B. These heterocyclic radicals expediently contain a substituent from the series already described above in the 4-position, in particular isopropyl, tert-butyl, benzyl and 2-pyridylmethyl.

According to a further alternative embodiment, R¹ and R² and/or R³ and R⁴ represent the 1,3-oxazolin-2-yl ring, which analogously contains a substituent from the above-mentioned series.

The chemical name for some examples of suitable ligands and the formulae of some complexes containing them follow below:

2,6-bis[1-(2,4,6-trimethylphenylimino)ethyl]pyridine (=TMAP)

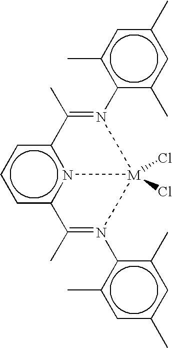

2,6-bis[1-(2,6-dimethylphenylimino)ethyl]pyridine (=DMAP)

2,6-bis[1-(2,6-diisopropylphenylimino)ethyl]pyridine (=DiPAP)

0,0′-bis(dimethylaminoethyl)pyridine 2,6-dialdoxime

0,0′-bis(ethyl)pyridine 2,6-dialdoxime

2,6-bis[N-1,3-oxazolin-2-ylimino)-1,3-oxazolin-2-ylmethyl]pyridine

2,6-bis[4-(2-pyridyl)methyl)-1,3-oxazolin-2-yl]pyridine (BiPOP)

2,6-bis[4-(4-imidazolylmethyl)-1,3-oxazolin-2-yl]pyridine

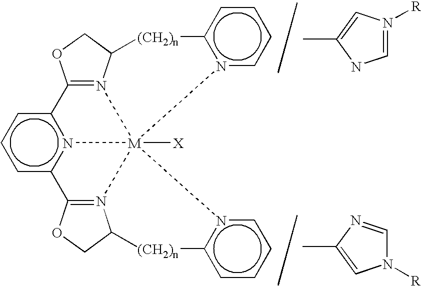

2,6-bis(4-isopropyl-1,3-oxazolin-2-yl)pyridine (=BiPOP)

2,6-bis-(4-benzyl-1,3-oxazolin-2-yl)pyridine (=Pybox)

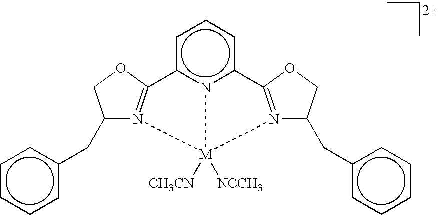

2,2-bis(4-tert-butyl-1,3-oxazolin-2-yl)propane

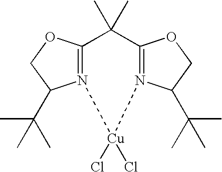

bis[4-tert-butyl-1,3-oxazolin-2-yl]methylamine

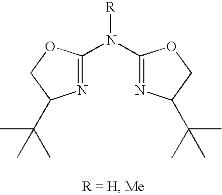

2,6-bis-(2-pyridyl)-ketone hydrate (DPKH)

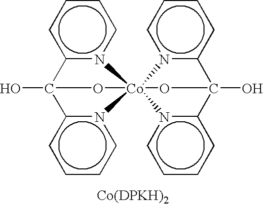

The ligands can be prepared by generally conventional processes—reference is made by way of example to J. Amer. Chem. Soc. (1998) 120,4049; Chem. Commun. (1989) 489; J. Organo. Lett. (1996), 507, 85; Tetrahedron (1994), 50(47), 13493; Org. Letters 2000, 2(14), 2045 and J. Amer. Chem. Soc. (1999, 121, 669 and 686).

The complexes to be used according to the invention can also be produced by known methods. For example, WO 99/46302 and WO 99/12981 describe polymerization catalysts having a nitrogen-containing transition metal complex, and a polydentate ligand corresponding to the general formula (I), in which B represents pyridine-2,6-diyl. However, these documents do not disclose the use of such complexes as bleaching catalysts.

Apart from the ligand, the catalyst can additionally contain coordinating co-ligands (X). X can be a mono-, di- or trivalent anion or a neutral molecule, which can be coordinated with the transition metal in a mono-, bi- or tridentate manner. The co-ligand is preferably selected from the following groupings: OH⁻, O²⁻, NO₃⁻, PO₄³⁻, CN⁻, SCN⁻, HSO₄⁻, SO₄²⁻, Cl⁻, Br⁻, F⁻, ClO₄⁻, OCN⁻, HCO₃⁻, RS⁻, CO₃²⁻, SO₃²⁻, RSO₃⁻, S₂O₆²—, RCO₂⁻, H₂O, ROH, CH₃CN, NRR′R″.

The counter-ion Y of the complex can be anionic or cationic, wherein the number p is chosen such that complete charge compensation is achieved. The counter-ion is preferably selected from: F⁻, Cl⁻, Br⁻, I⁻, NO₃⁻, RSO₃⁻ (R e.g. preferably CF₃), ClO₄⁻, RCO₂⁻, PO₄³⁻, HPO₄²⁻, H₂PO₄⁻, SO₄²⁻, HSO₄⁻, CO₃²⁻, HCO₃⁻, BF₄⁻, PF₆⁻, SO₃²⁻, Li⁺, Na⁺, K⁺, Mg²⁺, Ca²⁺, Ba²⁺.

The bleaching catalysts to be used according to the invention activate elemental oxygen and peroxy compounds. Peroxy compounds are to be understood as meaning, in particular, hydrogen peroxide, compounds which liberate hydrogen peroxide, such as, in particular, sodium perborate monohydrate, sodium perborate tetrahydrate and sodium percarbonate, perphosphates and persulfates, peroxycarboxylic acids and salts thereof and peroxycarboxylic acid bleaching precursors, so-called activators, and mixtures of such substances. Suitable peroxycarboxylic acids can be aliphatic or aromatic in nature and contain one or more peroxycarboxylic acid groups. Aliphatic peroxycarboxylic acids usually contain 1 to 20 C atoms, preferably 1 to 12 C atoms, and the particularly preferred peroxycarboxylic acid is peroxyacetic acid. Among the peroxycarboxylic acids with 2 peroxycarboxylic acid groups, those having 4 to 18 C atoms are preferred. Examples are diperoxyadipic acid, diperoxyazelaic acid, diperoxylauric acid and diperoxydodecanedioic acid, as well as salts of the acids mentioned, for example magnesium salts. Among the aromatic peroxycarboxylic acids there are, in particular, peroxybenzoic acid, m-chlorobenzoic acid, p-sulfonatoperoxybenzoic acid, diperoxyisophthalic acid, phthalimidopercaproic acid, 4,4′-sulfonyl-diperoxybenzoic acid and magnesium salts of these acids.

The peroxycarboxylic acids can also be formed in situ during use, and in particular from so-called activators, which are, in general, O-acyl compounds and N-acyl compounds. Such compounds form the corresponding peroxycarboxylic acid under perhydrolysis conditions in the presence of hydrogen peroxide or a source of hydrogen peroxide. Activators which are particularly prefered are: N,N,N′N′-tetraacetylethylenediamine (TAED), Na 1-methyl-2-benzoyloxybenzene-4-sulfonate, Na nonanoyloxybenzenesulfonate (NOBS), 2-(N,N,N-trimethylammonium)ethyl-sodium 4-sulfophenylcarbonate chloride (SPCC), and pentaacetylglucose, phthalic anhydride.

For activation of peroxy compounds, the transition metal complexes according to the invention are, in general, employed in an amount of 0.0001 to 50 wt. %, and preferably at 0.01 to 20 wt. %, based on the peroxy compounds. Bleaching agent compositions according to the invention comprise at least one peroxy compound and a transition metal complex in an active amount. Such compositions should have 0.001 to 50 wt. %, in particular 0.01 to 20 wt. % and particularly preferably 0.01 to 1 wt. % of a transition metal complex with a ligand according to the invention, based on the content of peroxy compounds or their precursors.

Bleaching agent compositions according to the invention can also additionally comprise one or more surfactants from the series consisting of anionic, cationic, zwitter-ionic and nonionic surfactants, in particular surfactants such as are used in conventional washing, bleaching and cleaning compositions. Bleaching agent compositions according to the invention can furthermore also comprise organic and/or inorganic builders, such as zeolites. Further constituents can be those such as are used in conventional washing, bleaching and cleaning compositions, including enzymes, pH regulators and conventional alkali metal carriers, such as alkali metal silicate and alkali metal carbonates.

### EXAMPLES

### Example 1

### Preparation of the Ligand 2,2-bis(tert-butyl-1,3-oxazolin-2-yl)propane (Bubox)

50 ml of a 0.5 N methanolic sodium hydroxide solution were added to a solution of 2.52 g (6.90 mmol) N,N′-bis[3,3-dimethyl-1-chlorobutyl]-2,2-dimethyl-1,3-propanediamide, which was prepared in accordance with J. Am. Chem. Soc. 1991, 726-728 (Supplementary Material), and the mixture was heated under reflux for 2 hours after the addition. It was then allowed to cool to room temperature and the reaction solution was concentrated to dryness in vacuo. 30 ml saturated NaCl solution were added to the crude product. The mixture was then extracted with 3×30 ml methylene chloride and the combined organic phases were dried over magnesium sulfate. After distillation of the solvent, a pale yellow oil was obtained, which rapidly crystallized. (Yield: 48%)

### Example 2

### Cu Complex with the Ligand of Example 1

A solution of 640 mg (2.17 mmol) bis(oxazolinyl)pyridine in 10 ml methylene chloride was added to a suspension of 291 mg (2.17 mmol) anhydrous copper chloride in methylene chloride. After stirring for 1 hour at room temperature, the solution was filtered and the filtrate was concentrated in vacuo. A pale green powder was obtained in a quantitative yield.

### Example 3A

### Fe Complex of BiPOP

420 mg (3.31 mmol) anhydrous FeCl₂ were added to 1.00 g (3.31 mmol) of the ligand 2,6-bis(4-isopropyl-1,3-oxazolin-2-yl)pyridine (synthesis in accordance with Chem. Comm. 1998, 849) in 10 ml methylene chloride. After the addition, the blue reaction solution was heated to 80° C. and stirred at this temperature for 10 minutes. After slow evaporation of the solvent, the residue was dried in vacuo at 50° C. The complex was obtained as a dark red crystalline powder. (Yield: 96%)

### Example 3B

### Co Complex of BiPOP

238 mg (1.00 mmol) cobalt(II) chloride hexahydrate were added to a solution of 301 mg (1.00 mmol) 2,6-bis(4-isopropyl-1,3-oxazolin-2-yl)pyridine in 10 ml tetra-hydrofuran at 40° C. and the mixture was stirred for 1 hour at 55° C. The solvent was then distilled off and the residue was dried in vacuo at 50° C. (Yield: 98%, blue-green powder)

### Examples 4 to 9

### Catalytic Activity of Complexes

The complexes of Examples 2, 3A, 3B and complexes prepared in an analogous manner or a manner known from the literature were investigated for their catalytic action by means of the Morin test and in some cases by means of a washing test.

Morin test: A sodium perborate monohydrate solution, a methanolic solution of tetraacetylethylenediamine and a dilute solution of the combination to be investigated are added to an aqueous Morin solution. After intensive mixing, the extinction/transmission is measured at 400 nm after 30 minutes at 30° C. The blank value is measured in the absence of the combination to be investigated.

Washing test: Laboratory washing apparatus type ATLAS LAUNDER-O-METER; Temperature: 30° C.; Washing time: 30 minutes; Water hardness: 14° d Staining: tea, in some cases also grass on cotton; Detergent recipe:

12.2% anionic surfactant

7.7% nonionic surfactant

2.0% soap

34.8% zeolite A

4.2% polycarboxylate

0.5% phosphonic acid

4.1% corrosion inhibitor

1.1% magnesium silicate

1.1% greying inhibitor (CMC)

2.2% sodium sulfate

4.1% sodium citrate

Bleaching Component:

17% sodium percarbonate

5% activator TAED

Metal complex: 2,400 ppm

Detergent concentration: 5 g/l

As a comparison, the base recipe plus percarbonate/TAED, but without a metal complex (=catalyst) was always run (CE1). This change in reflection compared with the starting fabrics is subtracted from the change in reflection achieved with percarbonate/TAED/bleaching catalyst. The results are shown in Table 1.

TABLE 1

| | Complex | | | Morin test | Washing test |
|---|---|---|---|---|---|
| No. | M | L | Xₒ | transmission % | (ΔR) % |
| 4 | Cu | Bubox | (Cl)₂ | 90 | n.d. |
| 5 | Fe | BiPOP | (Cl)₂ | n.d. | 0.3 |
| 6 | Co | BiPOP | (Cl)₂ | 94.6 | 5.3 |
| 7 | Co | TMAP | (Cl)₂ | 94.4 | 4.0 |
| 8 | Co | DMAP | (Cl)₂ | 94.4 | 3.8 |
| 9 | Co | DiPAP | (Cl)₂ | 93.0 | 4.4 |

The test results show that the catalysts according to the invention, in particular cobalt complexes, lead to a high increase in the activity of the peroxyacetic acid formed in situ from an activator (TAED) and perborate.

All references cited herein are fully incorporated by reference. Having now fully described the invention, it will be understood by one of ordinary skill in the art that the invention may be performed within a wide and equivalent range of conditions, parameters and the like, without affecting the spirit or scope of the invention or any embodiment thereof.

What is claimed is:

1. A transition metal complex which acts as a catalyst for the activation of a peroxy compound or of oxygen, comprising a transition metal (M) and a nitrogen-containing ligand (L), wherein said complex is mono- or polynuclear, the transition metal (M) is manganese, iron, cobalt or copper and the nitrogen-containing ligand (L) is at least pentadentate, and has the general formula: 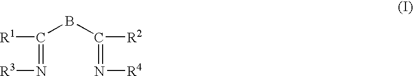
wherein B represents a bridge member from the series consisting of —O—, —S— 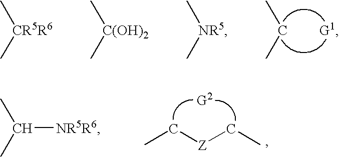
R¹ and R² independently of one another represent a radical from the group consisting of: H, linear, cyclic or branched alkyl, heteroalkyl, aryl, heteroaryl, arylalkyl and heteroarylalkyl,
R³ and R⁴ independently of one another represent a radical from the series consisting of aryl, heteroaryl, alkoxy, arylalkoxy, heteroarylalkyl and arylalkyl, wherein the organic radicals of R¹ to R⁴ can be substituted,
the groups R¹—C═N—R³ and/or R²—C═N—R⁴ independently of one another represent a five- to seven-membered N-heterocyclic or N-heteroaromatic ring, which additionally can contain one or two further heteroatoms selected from the group consisting of: O, N and S and can be substituted,
the bridge member 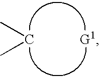
represents a five- or six-membered optionally substituted cycloalkyl or heterocycloalkyl group with one to 3 heteroatoms selected from the group consisting of: N, O and S and
the bridge member 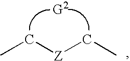
represents a five- to seven-membered optionally substituted cycloaliphatic, aromatic, heterocyclic or heteroaromatic radical, wherein Z is selected from the group consisting of: O, —N(R⁶)—, —N═or —C(OH)₂—; and the group G² can contain one or two heteroatoms selected from the group consisting of O, N and S and/or substituents,
R⁵ and R⁶ are independent of one another are defined according to the definition for R¹ set forth above, and
wherein substituents in R¹ to R⁶ and G¹ and G² are selected from the group consisting of: OH, COOH, SO₃H, NH₂, N⁺(alkyl)₄, SO₃⁻, CO₃⁻, Cl, F, (C₁-C₄)-alkoxy, (C₁-C₄)alkyl, phenyl, benzyl, pyridyl and 2-pyridylmethyl,
and with the proviso that ligands in which the bridge member B represents 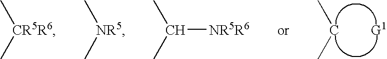
are excluded if the ring system formed from R¹—C═N—R³ and/or R²—C═N—R⁴ is other than an optionally substituted 1,3-oxazolin-2-yl ring, or if R³ and R⁴ are other than heteroaryl, heteroarylmethyl, alkoxy or aryloxy.

2. The transition metal complex of claim 1, wherein said ligand (L):
a) has a bridge member B with the formula: 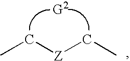
and
b) comprises a N-heterocyclic or N-heteroaromatic chosen from the group consisting of: pyridine-2,6-diyl, pyrrole-2,5-diyl, imidazole-2,5-diyl, piperidine-2,6-diyl, morpholino-3,5-diyl, pyrrolidine-2,5-diyl, and 1,3,5-triazine-2,6-diyl.

3. The transition metal complex of claim 2, wherein the groups R¹—C═N—R³ and R²—C═N—R⁴ in said ligand (L) are identical.

4. The transition metal complex of claim 3, wherein either the group R¹—C═N—R³ or the group R²—C═N—R⁴ of said ligand (L) is the 1,3-oxazolin-2-yl radical.

5. The transition metal complex of claim 1, wherein R¹ and R² and/or R³ and R⁴ represent the 1,3-oxazolin-2-yl ring.

6. The transition metal complex of claim 5, wherein one or more of said 1,3-oxazolin-2-yl radicals contain a substituent in the 4-position, selected from the group consisting of: isopropyl, tert-butyl, benzyl, 2-pyridylmethyl.

7. The transition metal complex of any one of claim 1-6, wherein said complex has the general formula [LₘMₙXₒ]Yₚ, wherein:
L denotes a ligand according to one of claims 1 to 6;
M denotes a transition metal selected from the group consisting of: Mn(II) to Mn(IV), Fe(II), Fe(III), Co(II), Co(III), Cu(I) and Cu(II);
X denotes a coordinating neutral or charged mono- or polyvalent ligand for saturation of the ligand sphere;
Y denotes a non-coordinating counter-ion which can be anionic or, if the sum of anionic ligands in the ligand L exceeds the sum of the valency of the metal atoms M, can also be cationic;
m denotes an integer in the range from 1 to 4, in particular 1 or 2;
n denotes the number 1 or 2;
o denotes zero or an integer in the range from 1 to 8; and
p denotes zero or an integer in the range from 1 to 8, in order to achieve complete charge compensation.

8. The transition metal complex of claim 7, wherein the radicals bonded to the bridge member B of the ligand L are identical.

9. A bleaching agent composition comprising a peroxy compound and the transition metal complex of any one of claims 1-6 present in an amount effective for the activation of said peroxy compound.

10. A bleaching agent composition comprising a peroxy compound and the transition metal complex of claim 7 present in an amount effective for the activation of said peroxy compound.

11. The bleaching agent composition of claim 10, wherein said peroxy compound is chosen from the group consisting of hydrogen peroxide; a source of hydrogen peroxide; a peroxycarboxylic acid having 2 to 18 C atoms; a combination of a source of hydrogen peroxide and a peroxycarboxylic acid precursor; and from mixtures thereof.

12. The bleaching agent composition according to claim 9, further comprising one or more surfactants.

13. The bleaching agent composition of claim 10, further comprising one or more surfactants.

14. The bleaching agent composition of claim 12, wherein said builders are zeolites.

15. The bleaching agent composition of claim 13 further comprising zeolites.

16. The bleaching agent composition according to claim 9, wherein said transition metal complex comprises 0.001 to 50 wt. % of said bleaching agent composition based on the content of peroxy compound or precursor thereof.

17. The bleaching agent composition of claim 16, wherein said transition metal complex comprises 0.01 to 20 wt. % of said bleaching agent composition based on the content of peroxy compound or precursor thereof.

18. The bleaching agent composition according to claim 10, wherein said transition metal complex comprises 0.001 to 50 wt. % of said bleaching agent composition based on the content of peroxy compound or precursor thereof.

19. The bleaching agent composition of claim 18, wherein said transition metal complex comprises 0.01 to 20 wt. % of said bleaching agent composition based on the content of peroxy compound or precursor thereof.

20. A method of bleaching a textile comprising contacting said textile with an aqueous solution containing the bleaching agent composition of claim 9 for a time and under conditions sufficient to accomplish said bleaching.

21. The method of claim 20, wherein said method is carried out at a temperature of less than 60° C.

22. A method of bleaching a textile comprising contacting said textile with an aqueous solution containing the bleaching agent composition of claim 10 for a time and under conditions sufficient to accomplish said bleaching.

23. The method of claim 22, wherein said method is carried out at a temperature of less than 60° C.
